(19) United States
(12) Patent Application Publication
(10) Pub. No.: US 2007/0180118 A1
(43) Pub. Date: Aug. 2, 2007

(54) MEDIA PLAYING APPARATUS

(75) Inventors: Chang Hyun Kim, Seoul (KR); Ku Bong Min, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/460,585

(22) Filed: Jul. 27, 2006

Related U.S. Application Data
(60) Provisional application No. 60/703,817, filed on Jul. 28, 2005.

(51) Int. Cl. G06F 15/173

(52) U.S. Cl. 709/226

(57) ABSTRACT

Disclosed herein is a media player. The media player includes a play and a station. The player decodes media data. The station includes a first connection and a second connection unit The first connection unit connects to a network and transmits and receives data. The second connection unit exchanges data with the first connection unit in a state of being connected to the player.

### CROSS-REFERENCE TO RELATED APPLICATIONS

This application claims priority under 35 U.S.C. § 119 to the U.S. Provisional application No. 60/703,817 filed on Jul. 28, 2005, the contents of which are hereby incorporated by reference herein in their entirety.

### BACKGROUND OF THE INVENTION

1. Field of the Invention

The present invention relates generally to a media playing apparatus and, more particularly, to a player device, and a stand device on which the player device is seated and through which the player device is charged with power, etc., the player device and the stand device being capable of being separated from each other.

2. Background of the Related Art

With the remarkable development of technology, recent portable devices have lighter weight and higher storage capacity, therefore many people frequently perform an operation of acquiring media data, such as audio data files in Moving Picture Experts Group Audio Layer-3 (MP3) format, via Personal Computers (PCs), connecting portable devices to the PCs, and then copying or moving and storing the acquired files in the storage means of the portable devices. By playing the above-described stored media files at the time desired by users, the users can enjoy the media files regardless of the time and location.

Meanwhile, when a speaker for outputting audio is mounted on such a portable device, it limits the possible weight reduction of the portable device, therefore the portable device is not equipped with a speaker but requires users to listen to audio via earphones. However, since the long-term use of earphones is excessively harmful to the sense of hearing, a user may wish to listen to audio content played via the portable device when the user remains in a defined space, such as a home or an office.

In order to satisfy such a desire, a device, in which a speaker is provided on a stand device 2 for charging a portable device 1 with power, such as a cradle or station, and audio data is provided to the stand device 2 via a connection port, such as a Universal Serial Bus (USB) port, while the portable device 1 is seated on the stand device 2, as shown in FIG. 1A, thereby outputting audio via the speaker provided in the stand device 2, has been developed and is currently being popularized

The construction of the device shown in FIG. 1A corresponds to a communication protocol structure shown in FIG. 1B so as to perform data communication. As exemplified in FIG. 1B, the portable device 1 and the stand device 2 are provided with peer physical layer/link layer protocols besides connection structures for charging the portable device 1 with power, the audio data decoded in the portable device 1 is transmitted to the stand device 2 via the protocols, undergoes necessary signal processing 2a, such as digital to analog conversion and signal amplification, in the stand device 2, and is then output as sound via the speaker 2b.

### SUMMARY OF THE INVENTION

Accordingly, the present invention has been made keeping in mind the above problems occurring in the prior art, and an object of the present invention is to provide a media player having a portable device and a stand device, in which a function of communication with a network is provided in the stand device, therefore the acquisition of media content is made convenient and various types of reproduction are enabled

In order to accomplish the above object, the present invention provides a media playing apparatus, including a player for decoding media data; and a station including a first connection unit for connecting to a network and transmitting and receiving data, and a second connection unit for exchanging data with the player in a state of being connected to the player.

In addition in order to accomplish the above object, the present invention provides a media playing apparatus, including a decoding unit configured to transmit signals which are obtained by decoding media data, to a station in a state of being seated on the station; and a stack structure including a hierarchically organized first protocol stack and a second protocol stack organized in parallel with the first protocol stack, the fist protocol stack being composed of a counterpart point-to-point port to be connected to a point-to-point communication port embedded in the station and a protocol for network connection, the second protocol stack being composed of a point-to-point port.

In an embodiment of the present invention, the first connection unit includes a physical layer for connection to a network, the second connection unit includes a point-to-point communication port, and the station relays data between the first and second connection units.

In a further embodiment of the present invention, the first connection unit includes a physical layer for connection to a network and a protocol for connection to a network above the physical layer, the second connection unit includes a point-to-point communication port, and the station relays data between tile first and second connection units.

In a still further embodiment of the present invention, the first connection unit includes a physical layer for connection to a network and a protocol for connection to a network above the physical layer, the second connection unit includes a point-to-point communication port and a protocol for connection to a network above the point-to-point communication port, and the station relays data between the first and second connection units.

In an embodiment of the present invention the point-to-point communication port is a USB port.

In an embodiment of the present invention, the protocol for connection to a network includes TCP/IP.

In an embodiment of the present invention, the station connects to a server on a network-via the first connection unit, searches for a media file, requests the transmission of the media file, and relays the transmitted media file to the player via the second connection unit.

In another embodiment of the present invention, the station connects to a server on a network via the first connection unit, searches for a media file, requests the transmission of the media file, stores the transmitted media file in a storage means, and provides the stored media file to the player via the second connection unit in response to a request from the player.

### BRIEF DESCRIPTION OF THE DRAWINGS

The above and other objects, features and advantages of the present invention will be more dearly understood from the following detailed description taken in conjunction with the accompanying drawings, in which:

FIG. 1A illustrates an example of a state in which a portable (mobile) media player is seated on a stand device and is charged with power;

FIG. 1B illustrates a construction related to the audio output of data, which is decoded in a portable media player, via a speaker provided in a stand device;

FIG. 2 illustrates an example of the construction of a media player connected to a network, according to the present invention;

FIGS. 3A and 3B illustrate the structure of the protocol stacks of the portable media player and stand device of FIG. 2 according to an embodiment of the present invention and the structure of the protocol stacks of the portable media player and stand device of FIG. 2 according to another embodiment of the present invention, respectively,

FIG. 3C illustrates the structure of the protocol stacks of the portable (mobile) player device and stand device of FIG. 2 according to still another embodiment of the present invention; and

FIGS. 4A and 4B illustrate the structure of the protocol stacks of tile portable player device and stand device of FIG. 2 according to a still further embodiment of the present invention and the structure of the protocol stacks of the portable player device and stand device of FIG. 2 according to a still further embodiment of the present invention, respectively.

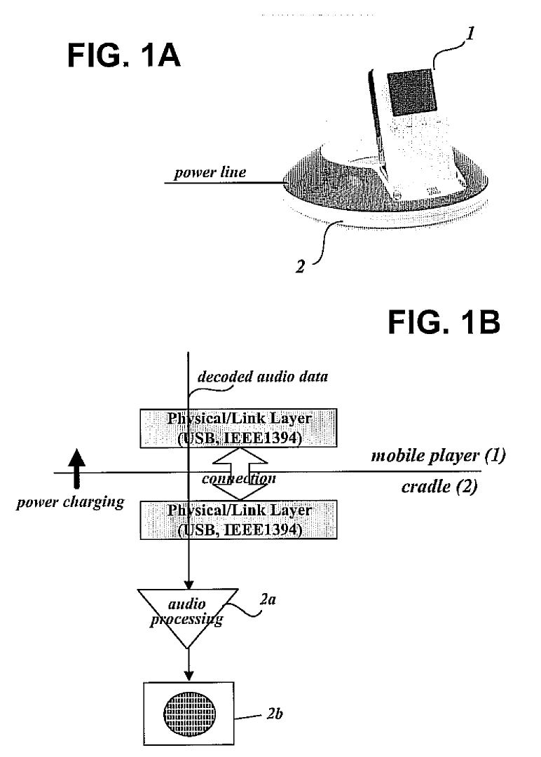

### DESCRIPTION OF THE PREFERRED EMBODIMENTS

Reference now should be made to the drawings, in which the same reference numerals are used throughout the different drawings to designate the same or similar components.

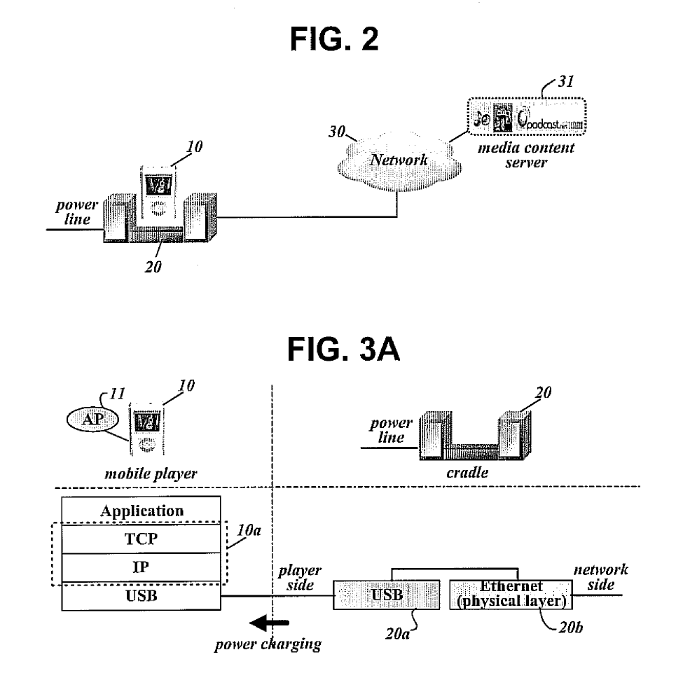

FIG. 2 illustrates an example of the construction of a media player connected to a network according to the present invention. The media player induces a portable (mobile) device 10 having a media reproduction function and a stand device 20 having a speaker. Furthermore, the stand device 20 has a function of connecting to a network, such as the Internet, and performing communication, besides a function of charging the portable device 10 with power. According to the present invention, the communication function of the stand device 20 may be implemented in various fashions. The portable device 10 may be an MP3 player that plays music files in MP3 format, or another small-size multimedia player that is equipped with a liquid crystal screen and can be carried.

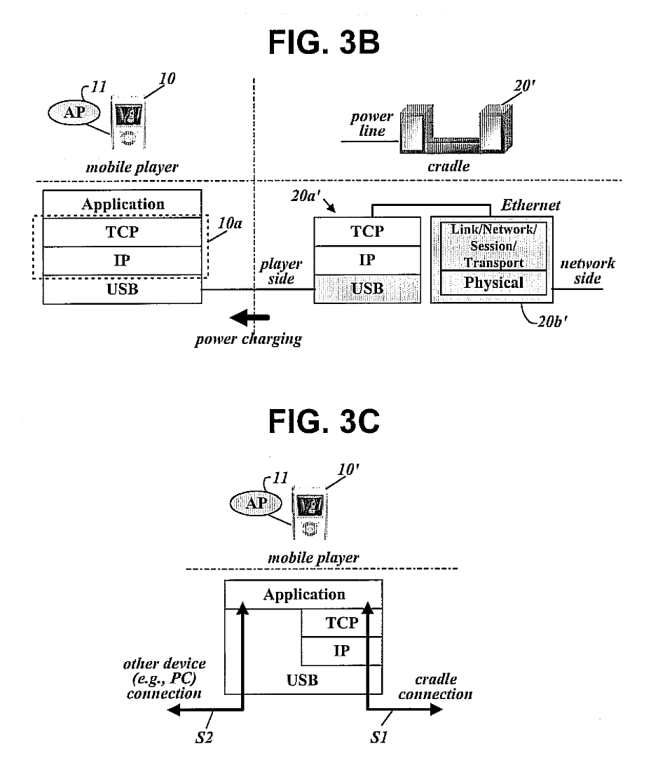

FIG. 3A illustrates an example of a protocol stack for a communication function that is constructed in the stand device 20, according to an embodiment of the present invention. In the embodiment of FIG. 3A, the stand device 20 includes a USB unit (or a USB port) 20a including a protocol for performing one-to-one communication with the portable device 10 and an Ethernet unit 20b including a protocol for connecting to and performing communication with a network 30. USB and Ethernet, used in the description of the present invention, are only examples. In place of USB, another connection protocol for point-to-point communication (for example, PS2 port) or a connection protocol for multi-to-multi communication (for example, IEEE1394 port) may be used, while, in place of Ethernet, another Local Area Network A) protocol for network connection may be used. This is applied to descriptions of other embodiments in the same manner. Furthermore, in the present embodiment, the Ethernet unit 20b includes only a physical layer protocol and is not used to further include a link layer or network layer protocol. However, in other embodiments of the present invention, the Ethernet protocol unit may include protocols for the lint layer and network layer above the physical Layer, as shown in FIG. 3B. In this case, a stand device 20′ is provided with a Transmission Control Protocol/Internet Protocol (TCP/IP) unit corresponding to that of the portable device 10 in a protocol unit 20a′ corresponding to that of the portable device 10, thereby matching the protocols of the network 30 and the portable device 10 to each other and relaying messages.

In the embodiment of FIG. 3A, in the case where the stand device 20 is connected to the portable device 10, the stand device 20 functions to relay messages. That is, a message received from the portable device 10, through the USB unit 20a is divested of a protocol header, is added with an Ethernet header via the Ethernet protocol unit 20b (or is converted into another type of signal) and is then transmitted to the network 30. In the reverse case, a message received via the Ethernet protocol 20b is divested of a protocol header, is added with a USB header via the USB unit 20a (or is converted into another type of signal), and is then transmitted to the portable device 10. For this relay function, a program (or hardware) for a required control function, besides the protocol units 20a and 20b shown in FIG. 3A, may be separately executed (or operated) in the stand device 20. Alternatively, it may be combined with one or both of the shown protocols 20a and 20b and then be executed.

The stand device 20 provides the above-described message relay function, with the result that an Application Program (AP) 11 corresponding to the application layer of the portable device 10 connects to a server on the network 30 via the TCP/IP unit 10a and performs required functions, such as search. For example, the application program 11 provides a Wireless Application Protocol (WAP) browser function.

Accordingly, while the portable device 10 is seated on the stand device 20, the user can start the application program 11 via an appropriate UI provided by the portable device 10, connect to a desired content server 31 for providing media content, such as music, in a streaming or download mode, and search for, select and receive desired media content. This received data is relayed by the stand device 20 to reach the portable device 10.

In the case where media content is received in a streaming mode, the application program 11 starts a media player suitable for the stream format and, thereby, decodes and outputs a stream. In this case, media data, such as audio data, decoded by the decoding unit (or decoding program) within the portable device 10 is transmitted to the stand device 20 as described above, and is output via a speaker (not shown) provided in the device.

In the case where media content is received in a non-streaming mode, that is, a download mode, the application program It stores the received data in an internal storage means (a hard disk, non-volatile memory, or the like) in file form. The management (selection, deletion and the like) of files stared as described above is carried out via a UI provided by the portable device 10.

Accordingly, while the portable device 10 is seated on the stand device 20 and is charged with power, the user can search a desired web site for desired media data, such as music, receive the media data, and play the media data, or store the media data and play the stored media data at the desired time.

In another embodiment of the present invention, the protocol stack of the portable device may be constructed as shown in FIG. 3C. In this embodiment, while the portable device 10′ is seated on the stand device 20 or 20′, the operation described with reference to FIG. 3A or 3B can be performed along a path SI via the TCP/IP unit in the same manner. A path S2 along which the application layer directly transmits and received data to and from the USB unit is used to connect to another device, such as a PC, and transmit and receive data. Accordingly, the user may directly connect the portable device 10′ to a PC and download a media file or the like stored in the PC to the portable device 10′ along the connection path S2, or acquire media data from the network 30 via the connection path S1 and the stand device 20 or 20′ in a streaming or download mode, Meanwhile, in order to directly connect the portable device 10′ to another device and acquire media data, a separate application program for that purpose is embedded in the portable device 10 and the program is selected via the UI provided by the portable device 10′.

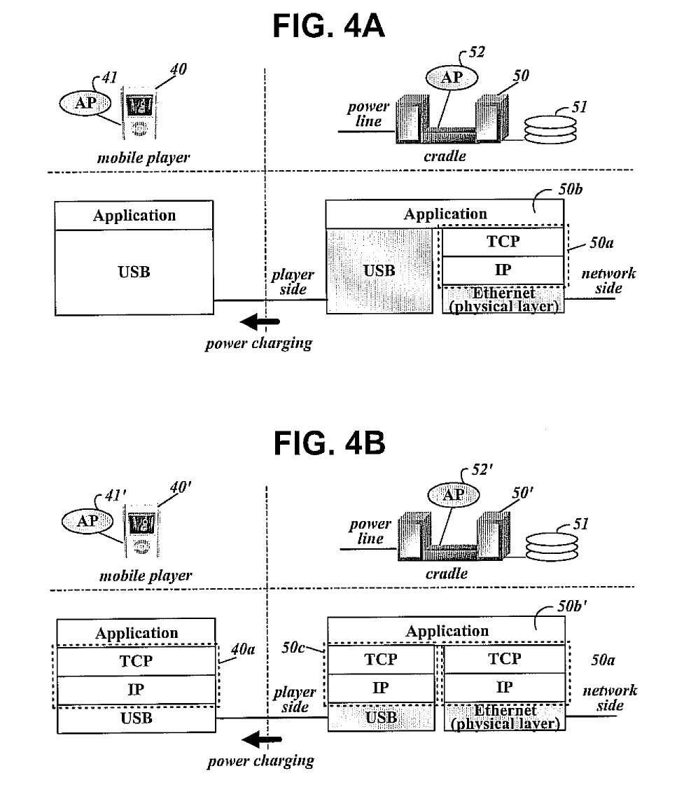

FIG. 4A illustrates another embodiment of the present invention. In the present embodiment the stand device 50 is provided with a separate storage means 51, for example, a hard disk or high-capacity memory. Furthermore, a TCP/IP unit Sa for connection to the network 30, and an application layer 50b for automatic connection to a network acquisition of media data, and communication with a portable device 40, corresponding to an application program 52, are also embedded in the stand device 50.

As a protocol for communication with the portable device 40, a USB unit for physical connection is provided. Accordingly, the portable device 40 enables communication between application programs 41 and 52 within the respective devices only via the USB unit. In the present embodiment, the portable device 40 may directly connect to a device other than the stand device 50, for example, a PC, and download media data via the USB unit as described above with reference to FIG. 3C.

In the embodiment of FIG. 4A, the application program 52 of the stand device 50 automatically connects a server, for example, a server 31 for providing media content, which is connected to the network 30, via a TCP/IP unit 50a according to a previously set method and information, searches for a media file, and downloads the media file. The downloaded media file is stored in the storage means 51. An example of searching for necessary files is periodically performing a search according to set information, finding files created since a previous search, and downloading the found files.

The set information is information that is set by the application program 52 of the stand device 50 based on information that is delivered from the application program 41 of the portable device 40 via a USB connection. This set information includes information about the location of a server or directory to be searched, for example, Uniform Resource Locators (URLs), information about a search cycle or search data, or information about files to be searched for. The user starts the application program 41 via the appropriate UI, provided by the portable device 40, inputs required information via a UT provided by the application program 41, and transmits the information to the application program 52 of the stand device 50, so information required for an operation to be automatically performed by the stand device 50 is set

Meanwhile, the application program 52 of the stand device 50 prepares a list of media files automatically searched for, received and stored as described above, and provides the list in response to a request via the application program 41 of the portable device 40. The list is prepared based on, for example, the file names of received media files and information about the time and dates of reception of the media files.

When a desired media file is selected from the list, received via the application program 41 of the portable device 40, and is requested, the application program 52 of the stand device 50 reads the corresponding media file from the storage means 51 based on selection information and provides the media file to the application program 41 of the portable device 40 via the USB connection. Then, the application program 41 of the portable device 40 stores the received media file in the storage means thereof

Meanwhile, the management (deletion or the like) of media files stored in the storage means 51 of the stand device 50 is performed by the application program 52 in such a way as to transfer appropriate commands to the application program 52 of the stand device 50 via the application program 41 of the portable device 40.

FIG. 4B illustrates another embodiment of the present invention. In the present embodiment, a stand device 50′ is provided with a separate storage means 51. A TCP/IP unit 50a for connection to the network 30, a corresponding TCP/IP unit 50c corresponding to a protocol unit 40a for connection to a network, which is provided in a portable device 40′, and an application layer 5b′ for automatic connection to a network., acquisition of media data and communication with the portable device 40′, which- corresponds to an application program 52′, are implemented in the stand device 50′.

Furthermore, in the present embodiment, the portable device 40′ is provided with a protocol for connection to a network, therefore the application program 41′ of the application layer can connect to a desired web site or directory via the stand device 50′. In the case, the stand device 50′ provides a protocol matching function, and is responsible for message relay via both TCP/IP units 50a and 50c. The function can be activated or inactivated via the application program 41′ in such a way as to transfer appropriate commands to the application program 52′ of the stand device 50′.

In the present embodiment, the automatic search, download and storage functions described with reference to FIG. 4A are performed in the same manner by the application program 50′. The information required for the function is set by the stand device 50′ based on the information input by the user via the application program 41′ of the portable device 40′ and transferred to the application program 52′ of the stand device 52′. The application program 52′ of the device 52′ uses the set information.

Meanwhile, in the present embodiment, the connection between the portable device 40′ and the stand device 50′ must be performed via TCP/IP units 40a and 50c for connection to a network therefore connection setup, such as the setup of a session, is first performed to transmit commands and/or responses between the two application programs 41′ and 52′. After tile connection setup, when a message relay function is inactivated, operations, such as an operation of receiving a stored file, a control operation and the like, can be performed on the stand device 50′ via the application program 52′. When the message relay function is activated, surfing and searching can be performed on the network, 30 via the portable device 40′. The application program 52′ of the stand device 50′ sets the inactivation of the message relay function for a basic mode. The reason for this is to enable the control of the stand device 50′ via the application program 52′ of the stand device 50′ by initializing the stand device 50′, at any time necessary.

Accordingly, in the present embodiment, the stand device 50′ acquires a list of media files downloaded in the storage means 51 thereof in an inactivated state of the message relay function after the network connection has been set up between the two application programs 41′ and 52′. After the list has been acquired, the selection of desired files and the copying or movement of the selected files to the stand device 50′ are performed in the same manner as those in the embodiment described with reference to FIG. 4A. The present embodiment is different from the embodiment of FIG. 4A only in that a media file is received via the TCP/IP units 40a and 50c for connection to a network, therefore the data of the file is transmitted in packet form.

In still another embodiment of the present invention, the portable device 40′ of FIG. 4B may have the protocol stack structure illustrated in FIG. 3C. When the portable device 40′ has the protocol stack structure illustrated in FIG. 3C, operations of directly connecting to a separate device, such as a PC, receiving a media file stored in the PC via a USB connection, and storing the media file in the storage means thereof, besides the operations described with reference to FIG. 4B, may be performed

Although the preferred embodiments of the present invention have been disclosed for illustrative purposes, those skilled in the art will appreciate that various modifications, additions and substitution are possible, without departing from the scope and spirit of the invention as disclosed in the accompanying claims.

What is claimed is:

1. An apparatus for playing media data, comprising:
a player for decoding media data; and
a station including a first connection unit for connecting to a network and transmitting and receiving data, and a second connection unit for exchanging data with the player in a state of being connected to the player.

2. The apparatus as set forth in claim 1, wherein the first connection unit comprises a physical layer for connection to a networks, the second connection unit comprises a point-to-point communication port, and the station relays data between the first and second connection units.

3. The apparatus as set forth in claim 2, wherein the point-to-point communication port is a Universal Serial Bus (USB) port.

4. The apparatus as set forth in claim 2, wherein the player comprises a stack structure composed a hierarchically organized first protocol stack and a second protocol stack arranged in parallel with the first protocol stack, the first protocol stack being composed of a counterpart point-to-point port to be connected to the point-to-point communication port and a protocol for network connection, the second protocol stack being composed of a point-to-point port.

5. The apparatus as set forth in claim 2, wherein the first connection unit further comprises a protocol, organized above the physical layer, for connection to a network, and the station relays data between the first and second connection units.

6. The apparatus as set forth in claim 5, wherein the second connection unit further comprises a protocol, organized above the point-to-point port, for connection to a network, and the station relays data between the first and second connection units.

7. The apparatus as set forth in claim 6, wherein the second protocol stack provides a data transfer path when the player is connected to a device other than the station.

8. The apparatus as set forth in claim 5, wherein the station further comprises storage means, and the station connects to a server on a network, via the first connection unit according to set information, searches for and downloads a media file, stores the media file in the storage means, and transmits the stored media file to the player via the second connection unit in response to a request from the player.

9. The apparatus as set forth in claim 8, wherein the set information is set based on information that is entered by a user via the player and is received via the second connection unit.

10. The apparatus as set forth in claim 5, wherein the protocol for connection to a network comprises Transmission Control Protocol/Internet Protocol (TCP/IP).

11. The apparatus as set forth in claim 1, wherein the first connection unit comprises a physical layer for connection to a network the second connection unit comprises a multi-to-multi communication port, and the station relays data between the first and second connection units.

12. The apparatus as set forth in claim 1, wherein the station comprises output means for outputting signals in sound.

13. The apparatus as set forth in claim 12, wherein the player provides the decoded media data to the output means via a path formed through the connection in a state of being connected to the station.

14. The apparatus as set forth in claim 1, wherein the player reads and decodes the media data stored therein.

15. The apparatus as set forth in claim 1, wherein the player decodes the media data that is being received via the second connection unit in a streaming mode.

16. The apparatus as set forth in claim 1, wherein the player stores the media data, which is received via the second connection unit in a non-streaming mode, in internal storage means.

17. The apparatus as set forth in claim 1, wherein the station charges the player with power when the player is seated thereon.

18. An apparatus for playing media data, comprising:
a decoding unit configured to transmit signals, which are obtained by decoding media data, to a station in a state of being seated on the station, and
a stack structure including a hierarchically organized first protocol stack and a second protocol stack organized in parallel with the first protocol stack the first protocol stack being composed of a counterpart point-to-point port to be connected to a point-to-point communication port embedded in the station and a protocol for network connection, the second protocol stack being composed of a point-to-point port.

19. The apparatus as set forth in claim 18, wherein the first protocol stack provides a data path for communication with the station, and the second protocol stack supports connection to a device other than the station and provides a data path over the connection.

20. The apparatus as set forth in claim 18, wherein the point-to-point port is a USB port.

21. The apparatus as set forth in claim 18, wherein the protocol for connection to a network comprises TCP/IP.
